(19) United States
(12) Patent Application Publication
(10) Pub. No.: US 2013/0198778 A1
(43) Pub. Date: Aug. 1, 2013

(54) APPARATUS AND METHOD FOR CONTROLLING PLAYBACK OF VIDEOS GROUPED IN A PLURALITY OF PLAYLISTS

(71) Applicant: Wong Hoo Sim, Singapore (SG)

(72) Inventor: Wong Hoo Sim, Singapore (SG)

(73) Assignee: CREATIVE TECHNOLOGY LTD, Singapore (SG)

(21) Appl. No.: 13/878,753

(22) PCT Filed: Oct. 6, 2011
(86) PCT No.: PCT/SG11/00349

§ 371 Date: Apr. 10, 2013

(30) Foreign Application Priority Data
Oct. 11, 2010 (SG) 201007438-3

(51) Int. Cl. H04N 21/472

(52) U.S. Cl. CPC H04N 21/47202
USPC 725/38

(57) ABSTRACT

There is provided an apparatus for controlling playback of videos grouped in a plurality of playlists. The apparatus may be for controlling a host device and includes a plurality of buttons. Each button is used to perform at least one task such as, for example, toggling the host device from a standby mode to an active mode and subsequently running a first video from one of the plurality of playlists associated with the button; playing back a second video from one of the plurality of playlists associated with the button; tagging a video frame from any video; skipping amongst videos grouped in one of the plurality of playlists associated with the button and so forth. A corresponding method is also provided.

### FIELD OF INVENTION

The present invention relates to control of video playback, primarily an apparatus and a method for controlling playback of videos grouped in a plurality of playlists.

### BACKGROUND

Videos are now commonly stored in digital format. As such, it is typical for a plurality of videos to be stored in non-volatile memory for playback at a later juncture. However, managing the videos for playback has typically been a challenging endeavour during instances when the number of videos is large.

The challenging aspect of managing the videos comes about because playing back the videos is less convenient compared to playing back audio. files. While audio files seldom exceed ten minutes during playback, video files are seldom less than ten minutes during playback. In this regard, previewing audio files is easier than previewing video files, especially since audio files typically have repetitive content. Thus, the managing of videos is less convenient because of the difficulty in previewing a video file and determining the contents of the video file. The problem of managing videos is exacerbated as a movie typically would comprise more than one file, and a need to group the aforementioned files together adds to the difficulty of the management of the videos.

Thus, it would be preferable if a large number of videos could be managed in a more efficient manner for the benefit of the users without having to carry out the tedious process of previewing content of a plurality of video files.

### SUMMARY

In a first aspect, there is provided an apparatus for controlling playback of videos grouped in a plurality of playlists. The apparatus may be for controlling a host device and includes a plurality of buttons. Each button is used to perform at least one task such as, for example, toggling the host device from a standby mode to an active mode and subsequently running a first video from one of the plurality of playlists associated with the button; playing back a second video from one of the plurality of playlists associated with the button; tagging a video frame from any video; skipping amongst videos grouped in one of the plurality of playlists associated with the button and so forth. It is advantageous that each button performs the at least one task at specific instances and with specific actions.

The first and the second videos are run in a manner such as, for example, in its entirety from start till end, from a tagged portion in the videos, from a last viewed portion in the videos and so forth. Portions of the first video may preferably be stored in buffer memory of the host device.

The buttons may be either physical or virtual. In addition, the videos may be stored at either the host device or a remote storage. Each playlist may preferable have a discrete theme.

The tagged video frame advantageously allows the video to be played back from the tagged video frame onwards. The tagging of a video frame from the video is performed when the button is pressed when a video from a playlist associated with the button is being played back. The toggling of the host device from the standby mode to the active mode is preferably performed when the button is pressed when the host device is in the standby mode.

The playback of the video from one of the plurality of playlists associated with the button is preferably performed when the button is pressed when a video from a playlist which is not associated with the button is being played back.

The skipping amongst videos grouped in one of the plurality of playlists is preferably performed when the button is pressed twice when a video from a playlist associated with the button is being played back. Preferably, a subsequent video after the skipping is run in a manner such as, for example, in its entirety from start till end, from a tagged portion in the subsequent video, from a last viewed portion in the subsequent video and so forth.

In a second aspect, there is provided a method for controlling playback of videos grouped in a plurality of playlists. The method includes pressing a button to toggle a host device from a standby mode to an active mode; playing back a video from a playlist associated with the button; pressing the button during playback of the video to tag a video frame from the video; and pressing the button twice during playback of the video to skip amongst the videos grouped in the playlist associated with the button.

The video being played back may be run in a manner such as, for example, in its entirety from start till end, from a tagged portion in the video, from a last viewed portion in the video and the like. Portions of the video from the playlist may be stored in buffer memory of the host device.

The buttons may be either physical or virtual. The videos may be stored at either the host device or a remote storage. Each playlist may preferably have a discrete theme.

Advantageously, the tagged video frame allows the video to be played back from the tagged video frame onwards.

A subsequent video after the skipping is preferably run in a manner such as, for example, in its entirety from start till end, from a tagged portion in the subsequent video, from a last viewed portion in the subsequent video and so forth.

### DESCRIPTION OF FIGURES

In order that the present invention may be fully understood and readily put into practical effect, there shall now be described by way of non-limitative example only preferred embodiments of the present invention, the description being with reference to the accompanying illustrative drawings.

FIG. 1 shows a first physical embodiment of an apparatus of the present invention.

FIG. 2 shows a second physical embodiment of the apparatus of the present invention.

FIG. 3 shows a process flow for a method of the present invention.

### DESCRIPTION OF PREFERRED EMBODIMENTS

It should be noted that the physical embodiments shown in the Figures are merely illustrative embodiments and as such, the physical embodiments of the present invention are not meant to be limited to the forms depicted in the Figures.

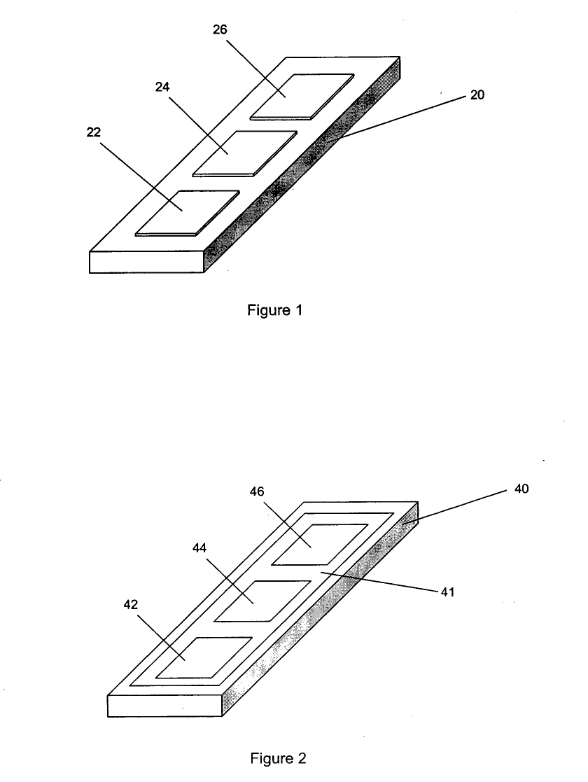

FIGS. 1 and 2 show first and second physical embodiments of an apparatus for controlling playback of videos grouped in a plurality of playlists. The apparatus is also usable for controlling a host device. Each playlist may have a discrete theme. The discrete theme may include, for example, genre, participating thespian, director, awards garnered, production date, viewing format and the like. The grouping of videos into the plurality of playlists may be carried out either using metadata of the videos or using contextual content of the videos. It should be appreciated that a video may be a part of more than one playlist. The videos are stored at either the host device or a remote storage. Videos at the remote storage are accessible through the host device when the host device is functionally connected to a data network.

Referring to FIG. 1, there is shown the apparatus 20 including a plurality of buttons 22, 24, 26. The plurality of buttons 22, 24, 26 are physical buttons in the apparatus 20. Referring to FIG. 2, there is shown the apparatus 40 with a touch screen display 41. A plurality of buttons 42, 44, 46 are depicted in the touch screen display 41. It should be noted that the plurality of buttons 42, 44, 46 are virtual buttons. The description in subsequent paragraphs would refer to both FIGS. 1 and 2 as they are similar in most aspects. It should be noted that while only three buttons are shown in the apparatus 20/40, the invention may extend to more than three buttons. The apparatus 20/40 may be either a standalone remote control or a part of a handheld device such as, for example, a mobile phone, a media player, a games device and so forth. It should be noted that being a part of the handheld device may include software running on the handheld device, the software controlling functionality of the virtual buttons which will be described in further detail in the subsequent paragraphs.

Each button 22/24/26/42/44/46 in the apparatus 20/40 is used to perform at least one task selected from a group of tasks which involve playback of the videos. A first task which each button 22/24/26/42/44/46 performs is toggling the host device from a standby mode to an active mode, and subsequently running a video from one of the plurality of playlists associated with the button. A playlist associated with the button may be either selectable by the user or assigned to the button without user intervention. It should be noted that assignment of the playlist to the button without user intervention may be carried out either in a random manner or at the point of manufacture of the apparatus 20/40.

The first task is similar to a quick-start option for the host device. The first task is performed when the button is pressed when the host device is in the standby mode. The quick-start option is convenient to users as it allows a user to view the video without much delay. The video may be run in its entirety from start till end, run from a tagged portion in the video or run from a last viewed portion in the video. The video being run may be a random choice from the playlist associated with the button or may be an ordered choice from the playlist associated with the button. The video may start without much delay because it is stored in buffer memory in the host device which enables fast access once the host device is in an active mode. It should be appreciated that the data stored in the buffer memory is dependent on processes run by the host device when the host device was last in an active mode. For example, either the starting portions of all videos may be stored in the buffer memory, or the last watched portions of all videos may be stored in the buffer memory.

A second task which each button 22/24/26/42/44/46 performs is playing back a video from a playlist associated with the button. The second task is performed when the button is pressed during the playback of a video from a playlist which is not associated with the button. The second task allows the user to switch between videos in a quick one-step manner. The subsequent video may be run in its entirety from start till end, run from a tagged portion in the subsequent video or run from a last viewed portion in the subsequent video. The subsequent video being played back may be a random choice from the playlist associated with the button or may be an ordered choice from the playlist associated with the button.

A third task which each button 22/24/26/42/44/46 performs is tagging a video frame from the video. The tagging of a video frame from the video is performed when the button is pressed when a video from a playlist associated with the button is being played back. The tagged video frame may serve as a marker and allows the video to be played back from the tagged video frame onwards. The third task allows the user to tag the video at more than one video frame such that the user is able to obtain quick access to the various portions of the video where the frames are marked.

A fourth task which each button 22/24/26/42/44/46 performs is skipping amongst the videos grouped in a playlist associated with the button. The skipping amongst the videos grouped in the playlist is performed when the button is pressed twice when a video from the playlist associated with the button is played back. The fourth task also allows the user to switch between videos in the same playlist in a quick one-step manner. After skipping, the subsequent video may be run in its entirety from start till end, run from a tagged portion in the subsequent video or run from a last viewed portion in the subsequent video. After skipping, the subsequent video being played back may be a random choice from the playlist associated with the button or may be an ordered choice from the playlist associated with the button.

It should be noted that each button 22/24/26/42/44/46 performs at least one of the aforementioned tasks at specific instances and with specific actions. As such, each button 22/24/26/42/44/46 is able to perform a plurality of actions at different instances and this eliminates a necessity to have extraneous buttons on the apparatus 20/40. Having fewer buttons on the apparatus 20/40 provides a perception of simplicity and correspondingly, a lack of complexity.

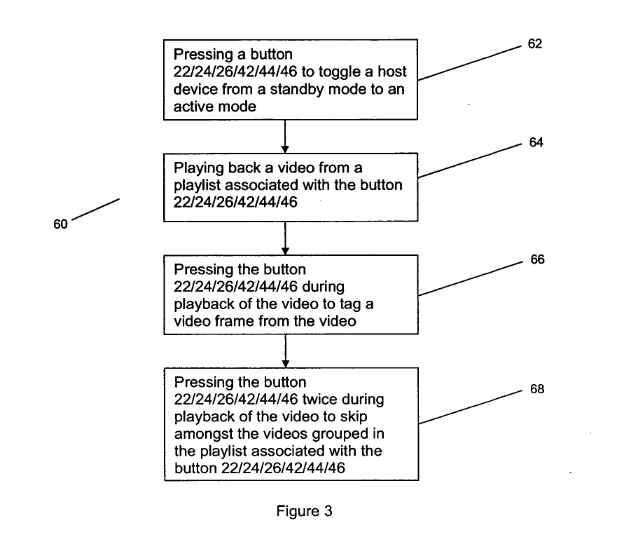

Referring to FIG. 3, there is shown a process flow for a method 60 for controlling playback of videos grouped in a plurality of playlists. The method 60 may involve use the apparatus 20/40 as described in the preceding paragraphs. As such, labels from FIGS. 1 and 2 will be used when describing FIG. 3 for purposes pertaining to clarity of the description.

Each playlist may have a discrete theme. The discrete theme may include, for example, genre, participating thespian, director, awards garnered, production date, viewing format and the like. The grouping of videos into the plurality of playlists may be carried out either using metadata of the videos or using contextual content of the videos. It should be appreciated that a video may be a part of more than one playlist. The videos are stored at either a host device or a remote storage. Videos at the remote storage are accessible through the host device when the host device is functionally connected to a data network.

The method 60 includes pressing a button 22/24/26/42/44/46 to toggle the host device from a standby mode to an active mode (62). The buttons 22/24/26/42/44/46 are either physical or virtual as described in the preceding paragraphs.

Subsequently, the method 60 includes playing back a video from a playlist associated with the button 22/24/26/42/44/46. At this juncture, the method 60 is similar to a quick-start option for the host device. The quick-start option is convenient to users as it allows a user to view the video without much delay. The video may be run in its entirety from start till end, run from a tagged portion in the video or run from a last viewed portion in the video. The video being run may be a random choice from the playlist associated with the button or may be an ordered choice from the playlist associated with the button. The video may start without much delay because it is stored in buffer memory in the host device which enables fast access once the host device is in an active mode. It should be appreciated that the data stored in the buffer memory is dependent on processes run by the host device when the host device was last in an active mode. For example, either the starting portions of all videos may be stored in the buffer memory, or the last watched portions of all videos may be stored in the buffer memory.

In the method 60, pressing the button 22/24/26/42/44/46 during playback of the video enables a video frame to be tagged from the video (66). The tagged video frame may serve as a marker and allows the video to be played back from the tagged video frame onwards. This step 66 may be repeated such that it allows the user to tag the video at more than one video frame so that the user is able to obtain quick access to the various portions of the video where the frames are marked.

In addition, in the method 60, pressing the button 22/24/26/42/44/46 twice during playback of the video enables skipping amongst the videos grouped in the playlist associated with the button 22/24/26/42/44/46 (68). This step 68 allows the user to switch between videos in the same playlist in a quick one-step manner. After skipping, the subsequent video may be run in its entirety from start till end, run from a tagged portion in the subsequent video or run from a last viewed portion in the subsequent video. After skipping, the subsequent video being played back may be a random choice from the playlist associated with the button 22/24/26/42/44/46 or may be an ordered choice from the playlist associated with the button 22/24/26/42/44/46.

It should be noted that the method 60 enables a plurality of actions at different instances to be carried out without a necessity to have extraneous buttons on the apparatus 20/40. Having fewer buttons on the apparatus 20/40 provides a perception of simplicity and correspondingly, a lack of complexity.

Whilst there has been described in the foregoing description preferred embodiments of the present invention, it will be understood by those skilled in the technology concerned that many variations or modifications in details of design or construction may be made without departing from the present invention.

1. An apparatus for controlling playback of videos grouped in a plurality of playlists, the apparatus being for controlling a host device and including a plurality of buttons, each button being used to perform at least one task selected from a group comprising:
toggling the host device from a standby mode to an active mode and subsequently running a first video from one of the plurality of playlists associated with the button;
playing back a second video from one of the plurality of playlists associated with the button;
tagging a video frame from any video; and
skipping amongst videos grouped in one of the plurality of playlists associated with the button,
wherein each button performs the at least one task at specific instances and with specific actions.

2. The apparatus of claim 1, wherein the buttons are either physical or virtual.

3. The apparatus of claim 1, wherein the videos are stored at either the host device or a remote storage.

4. The apparatus of claim 1, wherein the tagged video frame allows the video to be played back from the tagged video frame onwards.

5. The apparatus of claim 1, wherein the toggling of the host device from the standby mode to the active mode is performed when the button is pressed when the host device is in the standby mode.

6. The apparatus of claim 1, wherein the playback of the video from one of the plurality of playlists associated with the button is performed when the button is pressed when a video from a playlist which is not associated with the button is being played back.

7. The apparatus of claim 1, wherein the tagging of a video frame from the video is performed when the button is pressed when a video from a playlist associated with the button is being played back.

8. The apparatus of claim 1, wherein the skipping amongst videos grouped in one of the plurality of playlists is performed when the button is pressed twice when a video from a playlist associated with the button is being played back.

9. The apparatus of claim 8, wherein a subsequent video after the skipping is run in a manner selected from a group comprising: in its entirety from start till end, from a tagged portion in the subsequent video and from a last viewed portion in the subsequent video.

10. The apparatus of claim 1, wherein each playlist has a discrete theme.

11. The apparatus of claim 1, wherein the first and the second videos are run in a manner selected from a group comprising: in its entirety from start till end, from a tagged portion in the video and from a last viewed portion in the video.

12. The apparatus of claim 1, wherein portions of the first video are stored in buffer memory of the host device.

13. A method for controlling playback of videos grouped in a plurality of playlists, the method including:
pressing a button to toggle a host device from a standby mode to an active mode;
playing back a video from a playlist associated with the button;
pressing the button during playback of the video to tag a video frame from the video; and
pressing the button twice during playback of the video to skip amongst the videos grouped in the playlist associated with the button.

14. The method of claim 13, wherein the buttons are either physical or virtual.

15. The method of claim 13, wherein the videos are stored at either the host device or a remote storage.

16. The method of claim 13, wherein the tagged video frame allows the video to be played back from the tagged video frame onwards.

17. The method of claim 13, wherein each playlist has a discrete theme.

18. The method of claim 13, wherein the video is run in a manner selected from a group comprising: in its entirety from start till end, from a tagged portion in the video and from a last viewed portion in the video.

19. The method of claim 13, wherein a subsequent video after the skipping is run in a manner selected from a group comprising: in its entirety from start till end, from a tagged portion in the subsequent video and from a last viewed portion in the subsequent video.

20. The method of claim 13, wherein portions of the video from the playlist are stored in buffer memory of the host device.
